(19) United States
(12) Patent Application Publication
(10) Pub. No.: US 2018/0020123 A1
(43) Pub. Date: Jan. 18, 2018

(54) IMAGE READING APPARATUS

(71) Applicant: CANON KABUSHIKI KAISHA, Tokyo (JP)

(72) Inventor: Tadao Hayashide, Utsunomiya-shi (JP)

(21) Appl. No.: 15/520,880

(22) PCT Filed: Nov. 19, 2015
(86) PCT No.: PCT/JP2015/005795

§ 371 Date: Apr. 21, 2017

(30) Foreign Application Priority Data
Dec. 1, 2014 (JP) 2014-242900
Oct. 28, 2015 (JP) 2015-211970

(51) Int. Cl. H04N 1/48; H04N 1/195; G03B 17/54; H04N 1/00; G03B 21/10

(52) U.S. Cl. CPC H04N 1/484; G03B 17/54; H04N 1/00933; H04N 1/19594; H04N 2201/0084; G03B 21/10; H04N 2201/0436; H04N 2201/0452; H04N 2201/0458; H04N 2201/0081

(57) ABSTRACT

Provided is an image reading apparatus that can read an image with highly accurate and stable density and color while illuminating the image with a color sequential projector thereof. The image reading apparatus according to the present invention includes: an image pickup unit configured to image an original that is mounted on a mounting surface; a projecting unit configured to project an image on the mounting surface by sequentially switching and emitting light of a plurality of colors; and a control unit configured to control the projecting unit so as to project a first black image, a first color image, and a second black image in this order during the imaging by the image pickup unit.

### TECHNICAL FIELD

The present invention relates to an image reading apparatus. More particularly, the present invention relates to an image reading apparatus with a projector, which is configured to read an original image at a high resolution and with a stable image density and color.

### BACKGROUND ART

An image reading apparatus with a projector is hitherto known.

For example, in PTL 1, there is disclosed an image reading apparatus in which a projector projects a periodic pattern, and a three dimensional geometry is measured based on information on parallax between the pattern projected by the projector and a pattern read by the reading apparatus.

A projector can achieve uniform illumination in addition to projecting a pattern. Thus, the projector easily functions as an illuminating device used for reading image information.

Further, through specified display with the projector, the projector can also be used in instructing a user to perform an appropriate operation.

### CITATION LIST

### Patent Literature

PTL 1: Japanese Patent Application Laid-Open No. 2006-3276

### SUMMARY OF INVENTION

### Technical Problem

An image reading apparatus with a color sequential projector is used in recent years. However, such an image reading apparatus has the following problem. That is, if opening/closing of a camera shutter is not synchronized with operation of emitting light of respective colors from light sources of the projector in a cycle of an integer multiple of one frame, density and color of an original image to be taken are deteriorated, and, in addition, nonuniformity on a light receiving surface and the like develop. Further, a state of the deterioration varies every time the imaging is performed depending on the timing of exposure. Therefore, there is a problem in that operation of the image reading apparatus is not stable.

Accordingly, the present invention provides an image reading apparatus with a color sequential projector for illumination, which can read an image with highly accurate and stable density and color while illuminating an image with the light.

### Solution to Problem

According to one embodiment of the present invention, there is provided an image reading apparatus, including: an image pickup unit configured to image an original that is mounted on a mounting surface; a projecting unit configured to project an image on the mounting surface by sequentially switching and emitting light of a plurality of colors; and a control unit configured to control the projecting unit so as to project a first black image, a first color image, and a second black image in this order during the imaging by the image pickup unit.

### Advantageous Effects of Invention

The image reading apparatus according to the present invention can read an image with highly accurate and stable density and color while illuminating the image with the color sequential projector.

Further features of the present invention will become apparent from the following description of exemplary embodiments with reference to the attached drawings.

### BRIEF DESCRIPTION OF DRAWINGS

FIG. 1 is a perspective view of an image reading apparatus according to a first embodiment of the present invention.

FIG. 2 is a side sectional view of the image reading apparatus according to the first embodiment.

FIG. 3 is a perspective view of the image reading apparatus according to the first embodiment when operated to read an image.

FIG. 4 is a flow chart of image reading operation of the image reading apparatus according to the first embodiment.

FIG. 5 is an imaging timing chart of the image reading apparatus according to the first embodiment.

FIG. 6 is a flow chart of image reading operation of an image reading apparatus according to a second embodiment of the present invention.

FIG. 7 is an imaging timing chart of the image reading apparatus according to the second embodiment.

FIG. 8 is a flow chart of image reading operation of an image reading apparatus according to a third embodiment of the present invention.

FIG. 9 is an imaging timing chart of the image reading apparatus according to the third embodiment.

FIG. 10 is a flow chart of image reading operation of an image reading apparatus according to a fourth embodiment of the present invention.

FIG. 11 is an imaging timing chart of the image reading apparatus according to the fourth embodiment.

FIG. 12 is a schematic view of a projector provided to a related-art image reading apparatus.

FIG. 13A is a schematic view of a camera provided to the related-art image reading apparatus.

FIG. 13B is a schematic view of the camera provided to the related-art image reading apparatus.

FIG. 13C is a schematic view of the camera provided to the related-art image reading apparatus.

FIG. 14 is an imaging timing chart of the related-art image reading apparatus.

### DESCRIPTION OF EMBODIMENTS

Image reading apparatus according to embodiments of the present invention are described in the following with reference to the attached drawings. Note that, for the sake of easy understanding of the present invention, the drawings referred to in the following description are not necessarily drawn to scale.

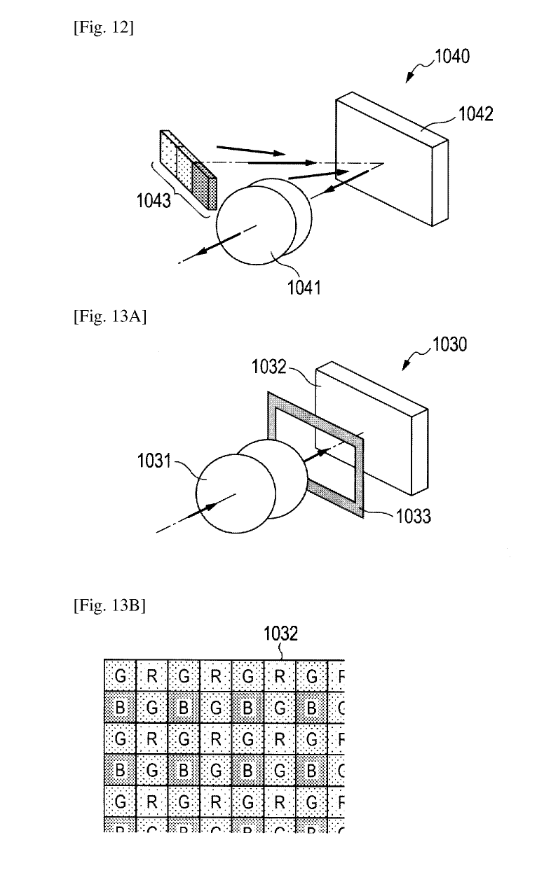

FIG. 12 is a schematic view of a projector 1040 provided to a related-art image reading apparatus.

The projector 1040 is a color sequential projector configured to switch and project light of various colors at high speed and thereby visually combining the colors.

The projector 1040 includes a projection lens 1041, a digital micromirror device (DMD) 1042 serving as a projection image element, and LEDs 1043 of three colors of RGB.

First, a red (R) LED of the LEDs 1043 emits light to illuminate the DMD 1042.

The DMD 1042 is a semiconductor element in which micromirrors are arranged. Orientations of the micromirrors can be individually controlled. Therefore, light directed toward the projection lens 1041 and light not directed toward the projection lens 1041 can be selectively determined depending on an illuminated location on the DMD 1042, and a projected image can be formed on a projection surface (not shown).

After the projected image in R is formed on the projection surface (not shown) by R light reflected by the DMD 1042, similarly, a projected image in green (G) is formed by G light. Then, similarly, a projected image in blue (B) is formed by B light. After that, a projected image in R is again formed, and these are repeated.

When the operation described above is repeated at high speed, a user visually reads an image in colors created through combining RGB. It is desired that the switching speed be about 60 or more frames per second, which means about 1/180 or less seconds per color.

The color sequential projector projects the colors in a time-sharing manner, and thus, a prism for dispersing light or a dielectric film having special reflection characteristics is not necessary. Therefore, the color sequential projector has a feature of being able to be manufactured in a small size at a low cost with a relatively small number of components.

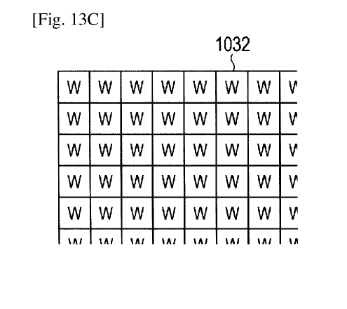

FIG. 13A to FIG. 13C are schematic views of a camera 1030 provided to the related-art image reading apparatus.

The camera 1030 includes an image pickup lens 1031, an image pickup element 1032, and a shutter 1033.

As the image pickup element 1032, for example, a charge coupled device (CCD) or a complementary metal-oxide semiconductor (CMOS) may be adopted. In the image pickup element 1032, light-receiving microelements are closely arranged on a light receiving surface so that two-dimensional image information can be obtained.

In the case of a color camera, the light-receiving microelements are arranged as illustrated in FIG. 13B, for example. In the case of a monochrome camera, the light-receiving microelements are arranged as illustrated in FIG. 13C, for example.

Light including the image information from an original (not shown) forms an image on the image pickup element 1032 through the image pickup lens 1031, and thus, an image on the original can be taken.

The mechanical shutter 1033 is arranged in an optical path. Opening/closing timing and shutter open time of the shutter 1033 are controlled by a control unit (not shown) so that an exposure amount of the image pickup element 1032 becomes appropriate.

Note that, according to the present invention, not only a mechanical shutter but also an electronic shutter may be adopted.

However, the related-art image reading apparatus in which the camera 1030 and the projector 1040 described above are combined has the following problem. That is, if opening/closing of the shutter 1033 of the camera 1030 is not synchronized with operation of emitting light of respective colors from the LEDs 1043 of the projector 1040 in a cycle of an integer multiple of one frame, density and color of an original image to be taken are deteriorated, and, in addition, nonuniformity on a light receiving surface and the like develop. Further, a state of the deterioration varies every time the imaging is performed depending on the timing of exposure. Therefore, there is a problem in that operation of the image reading apparatus is not stable.

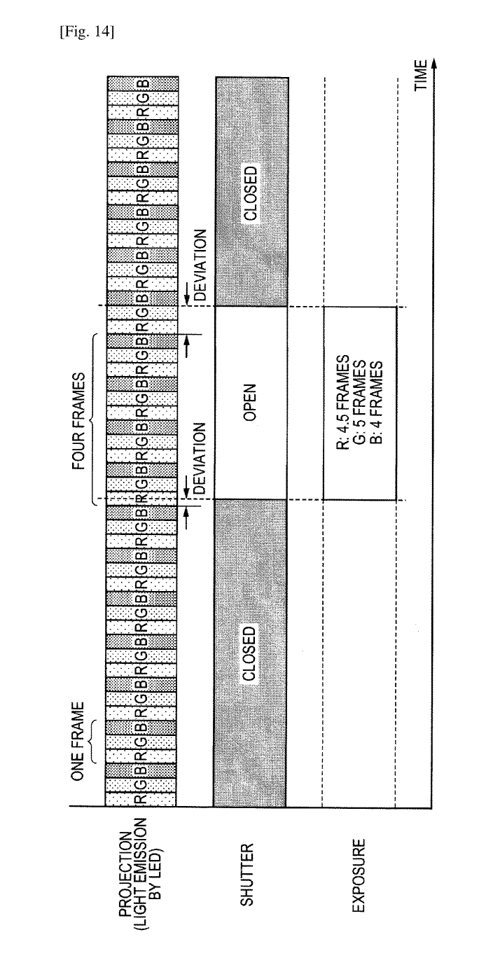

FIG. 14 is an imaging timing chart of the related-art image reading apparatus in which the camera 1030 and the projector 1040 are combined.

As described above, the projector 1040 performs projection through light emission by the LEDs 1043 in the order of RGB, and a cycle of RGB light emission is defined as one frame as a reference. Note that, one frame is set to be 1/60 seconds.

When the shutter 1033 is opened/closed so that the camera 1030 may image the original image in synchronous with exposure for 1/15 seconds, i.e., four frames, the timings of opening/closing may deviate from respective set values as illustrated in FIG. 14. Exemplary causes of the deviation include mechanical accuracy of the opening/closing of the shutter 1033 and a delay in electrical control signal from the control unit (not shown) to the shutter 1033.

Such deviations in the opening/closing of the shutter 1033 result in exposure frame numbers while the camera 1030 images the original image of 4.5 frames, five frames, and four frames for R, G, and B, respectively.

If all of the exposure frame numbers for RGB are not the same, original colors of the original image are not reproduced on the taken image. Further, if the exposure frame numbers are not an integer, nonuniformity in density and color develop on the light receiving surface.

Further, the accuracy of the opening/closing of the shutter 1033 is not fixed. In other words, the exposure frame numbers in the next exposure may not be the same as those in the current exposure. Therefore, it is impossible to correct taken images through uniform image processing.

It follows that such an image reading apparatus is impractical.

If the opening/closing of the shutter 1033 of the camera 1030 can be synchronized with the operation of emitting light of respective colors from the LEDs 1043 of the projector 1040, the problem described above can be solved.

However, in order to synchronize the operation of emitting light of respective colors from the LEDs 1043 of the color sequential projector 1040 at high speed with the opening/closing of the shutter 1033 of the camera 1030, electrically and mechanically advanced design is necessary, resulting in a higher cost of the image reading apparatus itself, which is not preferred.

On the other hand, if the synchronization is facilitated through setting of the speed of the operation of emitting light of respective colors from the LEDs 1043 to be lower, a new problem arises that a user cannot visually read an image in colors created through combining RGB with the color sequential projector 1040.

The problem described above arises not only in the case of a DMD element but also when an image display element such as liquid crystal is used.

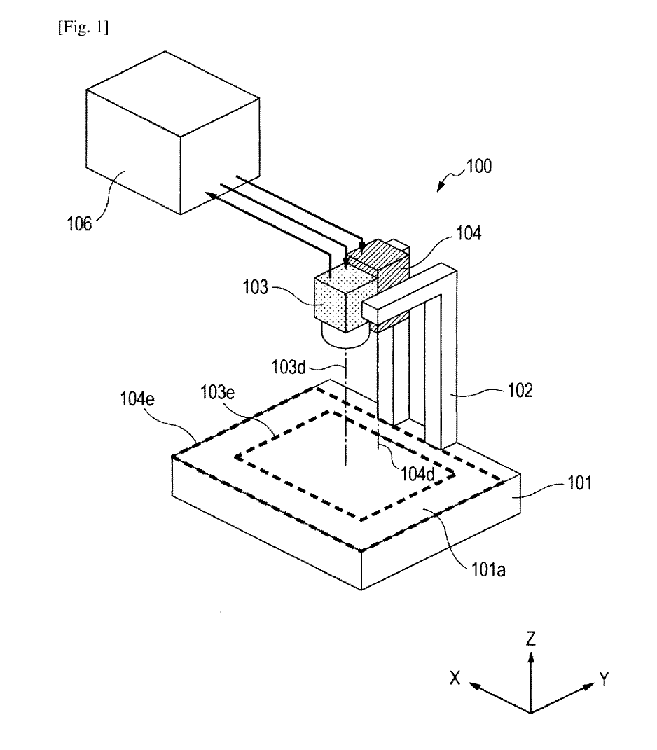

FIG. 1 is a perspective view of an image reading apparatus 100 according to a first embodiment of the present invention.

The image reading apparatus 100 includes a mount base 101, a frame 102, a camera (image pickup unit) 103, a projector (projecting unit) 104, and a control unit 106.

As can be seen from FIG. 1, the frame 102 is fixed on the mount base 101, and the camera 103 and the projector 104 are fixed to the frame 102. An original (not shown) is mounted on a mounting surface 101a of the mount base 101.

An imaging optical axis 103d of the camera 103 is in parallel with a normal to the mounting surface 101a of the mount base 101 (Z direction). A projection optical axis 104d of the projector 104 is also in parallel with the normal to the mounting surface 101a. Note that, the imaging optical axis 103d of the camera 103 and the projection optical axis 104d of the projector 104 are not necessarily required to be in parallel with the normal to the mounting surface 101a.

The camera 103 takes an image within an imaging range (image pickup range) 103e on the mount base 101 from above the mount base 101 (obtains a taken image).

The projector 104 projects an image (predetermined projection image) within a projection range 104e (on and around the original) on the mount base 101 from above the mount base 101. Note that, the projection range 104e is set so as to be asymmetrical with respect to the projection optical axis 104d.

The control unit 106 sends a projection image signal to the projector 104. Further, the control unit 106 sends a signal to instruct opening/closing of a shutter (not shown) to the camera 103, and receives and processes an image signal of an image taken by the camera 103.

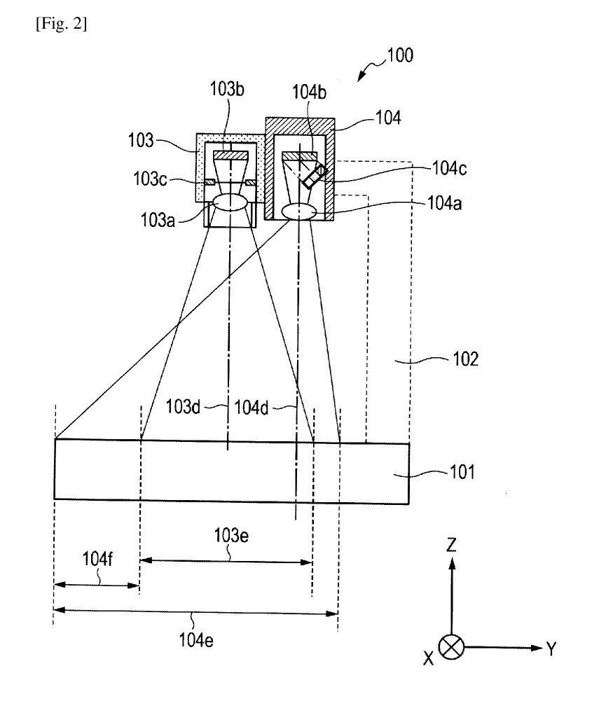

FIG. 2 is a side sectional view of the image reading apparatus 100 according to the first embodiment.

As illustrated in FIG. 2, the camera 103 includes an image pickup lens 103a, an image pickup element 103b, and a shutter 103c. Note that, the image pickup element 103b is a color sensor as illustrated in FIG. 13B.

The projector 104 includes a projection lens 104a, a DMD 104b serving as a projection image element, and LEDs of three colors of RGB (light sources for sequentially switching and emitting light of a plurality of colors) 104c.

As illustrated in FIG. 2, light including image information that comes from the imaging range 103e forms an image on the image pickup element 103b through the image pickup lens 103a, and thus, an image on the original can be taken. The mechanical shutter 103c is arranged in an optical path. Opening/closing timing and open time of the shutter 103c is controlled by the control unit 106 so that an exposure amount of the image pickup element 103b becomes appropriate.

In the projector 104, first, an R LED of the LEDs 104c emits light to illuminate the DMD 104b. The DMD 104b directs the emitted R light toward the projection lens 104a, thereby projecting the light onto the projection range 104e. Then, G light is projected onto the projection range 104e, and after that, B light is projected onto the projection range 104e. Then, R light is again projected onto the projection range 104e, and these are repeated.

Note that, a portion of the projection range 104e on a side opposed to the frame 102 (side that does not have the frame 102) other than the imaging range 103e is hereinafter referred to as an operation guide display range 104f.

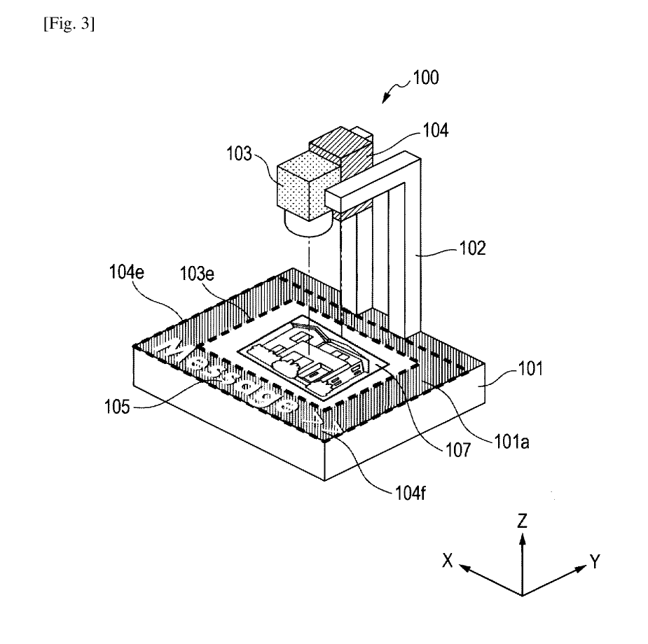

FIG. 3 is a perspective view of the image reading apparatus 100 according to the first embodiment when operated to read an image.

For example, the projector 104 projects an operation guide display 105 such as “Set original” onto the operation guide display range 104f on the mounting surface 101a of the mount base 101. In other words, the projector 104 projects a predetermined image in the region of the projection range 104e other than the image pickup range.

A user sets an original 107 to be read in the imaging range 103e.

Then, the projector 104 sequentially projects light in RGB in the imaging range 103e on the mounting surface 101a.

When projection by the projector 104 becomes stable, the camera 103 opens/closes the shutter 103c to image the original 107. Data of an image obtained by the imaging is processed by the control unit 106 and the image data is transferred to a memory unit (not shown) such as an SD card. If the image data is transferred to a printer or a personal computer, the image reading apparatus 100 can be used as a part of a copying machine or an image scanner.

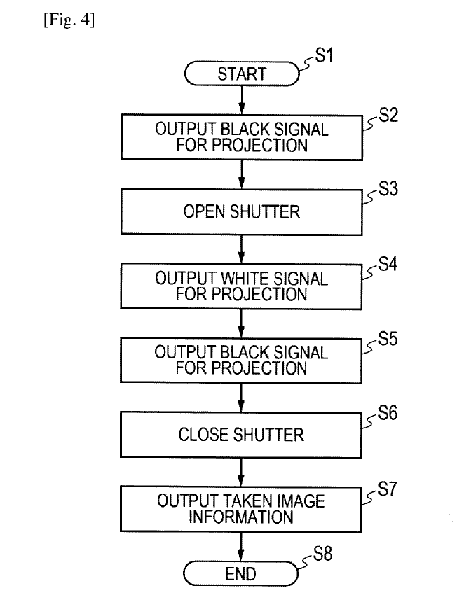

FIG. 4 is a flow chart of image reading operation of the image reading apparatus 100 according to the first embodiment.

When the image reading apparatus 100 starts the image reading operation (51), the control unit 106 outputs, to the projector 104, a black signal for projecting black in the imaging range 103e (S2). With this, the imaging range 103e in which the original is set is in a non-illuminated state.

Then, the shutter 103c of the camera 103 is opened (S3). However, the imaging range 103e in which the original is set is in the non-illuminated state, and thus, exposure of the camera 103 is substantially not made.

After that, the control unit 106 outputs, to the projector 104, a white signal for projecting white in the imaging range 103e (S4). With this, the imaging range 103e in which the original is set is now in an illuminated state. At this time of outputting the white signal, exposure of the camera 103 substantially starts.

Then, the control unit 106 outputs, to the projector 104, the black signal for projecting black in the imaging range 103e (S5). With this, the imaging range 103e in which the original is set is again in the non-illuminated state.

Next, the shutter 103c of the camera 103 is closed (S6). Taken image information that is obtained is output from the camera 103 to the control unit 106 (S7), and the image reading apparatus 100 ends the image reading operation (S8).

Therefore, an exposure time is determined by a time period during which the white signal is output. Specifically, the exposure time corresponds to a time period from the time at which the white signal is output in Step S4 to the time at which the black signal is output in Step S5.

Note that, in this case, the black signal means a signal that sets the projector 104 to be in a no light emitting state, and the white signal means a signal for the projector 104 to sequentially project light in RGB.

In the image reading apparatus 100 according to this embodiment, the projector 104 projects a first black image, a white (first color) image, and a second black image in this order. While the first black image is projected, the camera 103 opens the shutter 103c and starts imaging. While the second black image is projected, the camera 103 closes the shutter 103c, ends the imaging, and obtains a taken image.

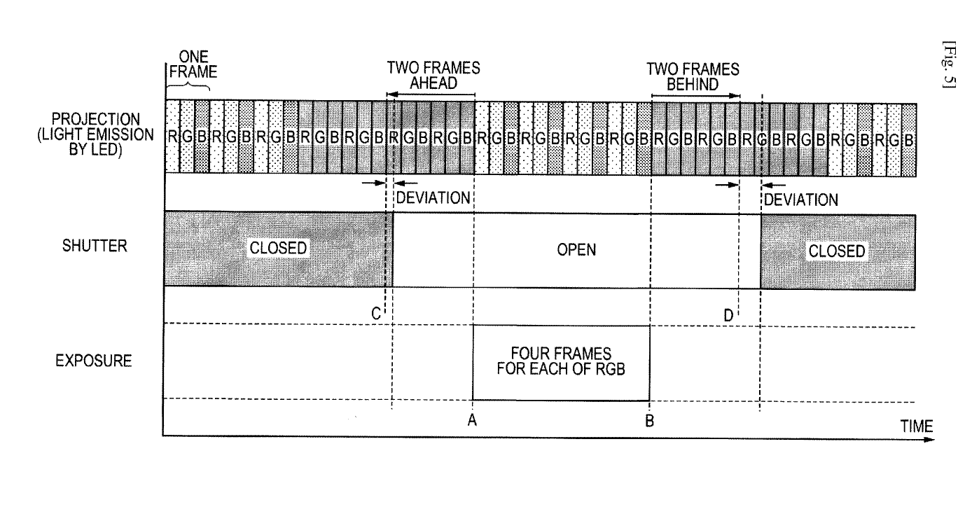

FIG. 5 is an imaging timing chart of the image reading apparatus 100 according to the first embodiment.

The projector 104 performs the projection through light emission by the LEDs 104c in the order of RGB, and a cycle of RGB light emission is defined as one frame as a reference. Note that, one frame is set to be 1/60 seconds.

In this embodiment, the control unit 106 outputs to the projector 104 the white signal for projecting white in the imaging range 103e for 1/15 seconds, i.e., four frames so that the imaging range 103e in which the original is set is in the illuminated state. Specifically, a time period from a timing A at which the white signal starts being output to the projector 104 to a timing B at which the black signal starts being output to the projector 104 is four frames.

Taking into consideration error in the opening/closing of the shutter 103c, the control unit 106 sends, to the camera 103, a signal to instruct opening/closing of the shutter 103c so that the shutter 103c is open from a timing C that is two frames ahead of the timing A to a timing D that is two frames behind the timing B.

As illustrated in FIG. 5, the opening/closing timings of the shutter 103c deviate from the set values. However, the imaging range 103e in which the original is set is in the non-illuminated state around the opening/closing timings C and D, and thus, the exposure of the camera 103 is not affected.

The camera 103 has a substantial exposure amount of four frames for each of RGB, and colors of the taken image that is obtained are reproduction of original colors of the original image. Further, the exposure frame numbers are an integer, and thus, nonuniformity in density and color does not develop on the light receiving surface.

Therefore, the image reading apparatus 100 according to this embodiment can read an image with highly accurate and stable density and color while illuminating the image with the color sequential projector.

Next, an image reading apparatus according to a second embodiment of the present invention is described. The image reading apparatus according to the second embodiment is the same as the image reading apparatus 100 according to the first embodiment except that the image pickup element 103b is not a color sensor as illustrated in FIG. 13B but a monochrome sensor as illustrated in FIG. 13C, and thus, like reference symbols are used to designate like members and description of the structure of the image reading apparatus is omitted.

A color sensor can collect color information at one time. However, the color sensor performs color separation using a so-called Bayer layout, and thus, the resolution in the light receiving surface is lowered.

On the other hand, a monochrome sensor cannot disperse light, but the resolution is not lowered, and thus, the monochrome sensor is suitable for reading a high-resolution image.

With the image reading operation, which is effectively modified, the image reading apparatus according to the second embodiment can also read an image with highly accurate and stable density and color at a high resolution.

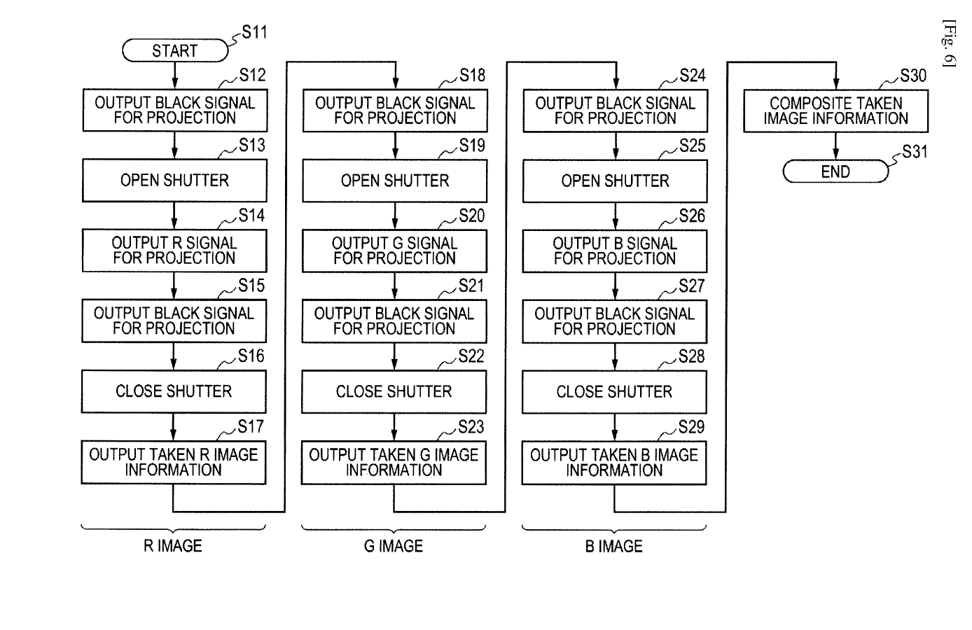

FIG. 6 is a flow chart of the image reading operation of the image reading apparatus according to the second embodiment.

When the image reading apparatus according to the second embodiment starts the image reading operation (S11), the control unit 106 outputs, to the projector 104, the black signal for projecting black in the imaging range 103e (S12). With this, the imaging range 103e in which the original is set is in the non-illuminated state.

Then, the shutter 103c of the camera 103 is opened (S13). However, the imaging range 103e in which the original is set is in the non-illuminated state, and thus, exposure of the camera 103 is substantially not made.

After that, the control unit 106 outputs, to the projector 104, an R signal for projecting R in the imaging range 103e (S14). With this, the imaging range 103e in which the original is set is in a state of being illuminated with R. At this time of outputting the R signal, exposure of the camera 103 with R substantially starts.

Then, the control unit 106 outputs, to the projector 104, the black signal for projecting black in the imaging range 103e (S15). With this, the imaging range 103e in which the original is set is again in the non-illuminated state.

Next, the shutter 103c of the camera 103 is closed (S16). Taken image information that is obtained with regard to R is output from the camera 103 to the control unit 106 (S17).

Then, the control unit 106 outputs, to the projector 104, the black signal for projecting black in the imaging range 103e (S18). With this, the imaging range 103e in which the original is set is in the non-illuminated state.

Next, the shutter 103c of the camera 103 is opened (S19). However, the imaging range 103e in which the original is set is in the non-illuminated state and thus, exposure of the camera 103 is substantially not made.

After that, the control unit 106 outputs, to the projector 104, a G signal for projecting G in the imaging range 103e (S20). With this, the imaging range 103e in which the original is set is in a state of being illuminated with G. At this time of outputting the G signal, exposure of the camera 103 with G substantially starts.

Then, the control unit 106 outputs, to the projector 104, the black signal for projecting black in the imaging range 103e (S21). With this, the imaging range 103e in which the original is set is again in the non-illuminated state.

Next, the shutter 103c of the camera 103 is closed (S22). Taken image information that is obtained with regard to G is output from the camera 103 to the control unit 106 (S23).

Then, the control unit 106 outputs, to the projector 104, the black signal for projecting black in the imaging range 103e (S24). With this, the imaging range 103e in which the original is set is in the non-illuminated state.

Next, the shutter 103c of the camera 103 is opened (S25). However, the imaging range 103e in which the original is set is in the non-illuminated state and thus, exposure of the camera 103 is substantially not made.

After that, the control unit 106 outputs, to the projector 104, a B signal for projecting B in the imaging range 103e (S26). With this, the imaging range 103e in which the original is set is in a state of being illuminated with B. At this time of outputting the B signal, exposure of the camera 103 with B substantially starts.

Then, the control unit 106 outputs, to the projector 104, the black signal for projecting black in the imaging range 103e (S27). With this, the imaging range 103e in which the original is set is again in the non-illuminated state.

Next, the shutter 103c of the camera 103 is closed (S28). Taken image information that is obtained with regard to B is output from the camera 103 to the control unit 106 (S29).

Finally, the control unit 106 synthesizes the taken image information that is input with regard to the three colors of RGB to obtain a color image (S30), and the image reading apparatus according to the second embodiment ends the image reading operation (S31).

In the image reading apparatus according to this embodiment, the projector 104 projects a first black image, an image in R, a second black image, an image in G, a third black image, an image in B, and a fourth black image in this order. While the first black image is projected, the camera 103 opens the shutter 103c and starts imaging. While the second black image is projected, the camera 103 closes the shutter 103c, ends the imaging, and obtains a first taken image of the original. While the second black image is projected, the camera 103 opens the shutter 103c and starts imaging. While the third black image is projected, the camera 103 closes the shutter 103c, ends the imaging, and obtains a second taken image of the original. While the third black image is projected, the camera 103 opens the shutter 103c and starts imaging. While the fourth black image is projected, the camera 103 closes the shutter 103c, ends the imaging, and obtains a third taken image of the original. Finally, the control unit 106 synthesizes the first taken image, the second taken image, and the third taken image to obtain a composite image.

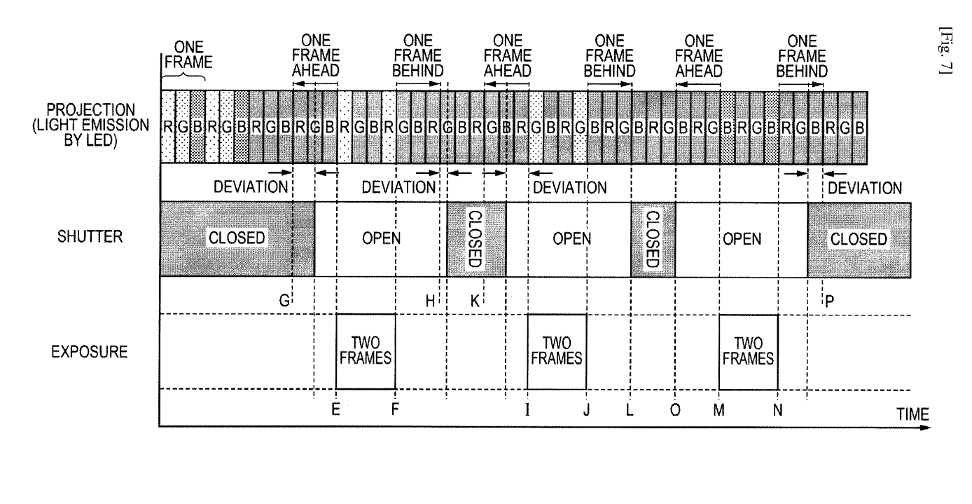

FIG. 7 is an imaging timing chart of the image reading apparatus according to the second embodiment.

The projector 104 performs the projection through light emission by the LEDs 104c in the order of RGB, and a cycle of RGB light emission is defined as one frame as a reference. Note that, one frame is set to be 1/60 seconds.

In this embodiment, the control unit 106 outputs to the projector 104 the color signals for projecting the respective colors in the imaging range 103e for 1/30 seconds, i.e., two frames so that the imaging range 103e in which the original is set is in the illuminated state.

Specifically, first, a time period from a timing E at which the R signal starts being output to the projector 104 to a timing F at which the next black signal starts being output to the projector 104 is two frames.

Taking into consideration error in the opening/closing of the shutter 103c, the control unit 106 sends, to the camera 103, a signal to instruct opening/closing of the shutter 103c so that the shutter 103c is open from a timing G that is one frame ahead of the timing E to a timing H that is one frame behind the timing F.

As illustrated in FIG. 7, the opening/closing timings of the shutter 103c deviate from the set values. However, the imaging range 103e in which the original is set is in the non-illuminated state around the opening/closing timings G and H, and thus, the exposure of the camera 103 with R is not affected.

Next, a time period from a timing I at which the G signal starts being output to the projector 104 to a timing J at which the next black signal starts being output to the projector 104 is two frames.

Taking into consideration error in the opening/closing of the shutter 103c, the control unit 106 sends, to the camera 103, a signal to instruct opening/closing of the shutter 103c so that the shutter 103c is open from a timing K that is one frame ahead of the timing I to a timing L that is one frame behind the timing J.

As illustrated in FIG. 7, the opening/closing timings of the shutter 103c deviate from the set values. However, the imaging range 103e in which the original is set is in the non-illuminated state around the opening/closing timings K and L, and thus, the exposure of the camera 103 with G is not affected.

A time period from a timing M at which the B signal starts being output to the projector 104 to a timing N at which the next black signal starts being output to the projector 104 is two frames.

Taking into consideration error in the opening/closing of the shutter 103c, the control unit 106 sends, to the camera 103, a signal to instruct opening/closing of the shutter 103c so that the shutter 103c is open from a timing O that is one frame ahead of the timing M to a timing P that is one frame behind the timing N.

As illustrated in FIG. 7, the opening/closing timings of the shutter 103c deviate from the set values. However, the imaging range 103e in which the original is set is in the non-illuminated state around the opening/closing timings O and P, and thus, the exposure of the camera 103 with B is not affected.

The camera 103 has a substantial exposure amount of two frames for each of RGB, and colors of the taken image that is obtained are reproduction of original colors of the original image. Further, the exposure frame numbers are an integer, and thus, nonuniformity in density and color does not develop on the light receiving surface.

Therefore, the image reading apparatus according to this embodiment can read an image at a high resolution and with highly accurate and stable density and color while illuminating the image with the color sequential projector.

Note that, in the image reading apparatus according to this embodiment, during the image reading operation, flicker and color change occur at high speed in the imaging range 103e.

Seeing the flicker and color change at high speed may cause user discomfort. Through appropriate guide display in the operation guide display range 104f to instruct the user to look at the operation guide display range 104f during the image reading operation, the user can take an image without discomfort.

Further, in the image reading apparatus according to this embodiment, compared with the case of the image reading apparatus 100 according to the first embodiment, exposure time per color is shorter. However, the monochrome sensor does not include a color filter for color separation and highly sensitive, and thus, the exposure amount is sufficient.

In this embodiment, the shutter is closed every time after projection of light of R, G, or B, but the present invention is not limited thereto. The shutter may be controlled so as to be opened while the (first) black image is projected before the image in R is projected, and after that, to be kept unclosed while the images in G and in B are sequentially projected as described above, and to be closed while the (sixth) black image is projected. In this case, the first taken image for the projection in R is read from the image pickup element after the projection in R and before the projection in G. The second taken image for the projection in G is read from the image pickup element after the projection in G and before the projection in B. The third taken image for the projection in B is read from the image pickup element after the projection in B. The first, second, and third taken images obtained in this way are combined, thereby being capable of obtaining action and an effect similar to those of the second embodiment.

Next, an image reading apparatus according to a third embodiment of the present invention is described. In the image reading apparatus according to the third embodiment, the image pickup element 103b is a color sensor as illustrated in FIG. 13B.

In the first embodiment and the second embodiment, a case is assumed in which external light that reaches the imaging range from around the image reading apparatus is sufficiently darker than the illumination of the imaging range by the projector.

However, a case is also assumed in which the image reading apparatus is used in an environment in which external light is bright. In this case, particularly an image reading apparatus using a low-priced and dark LED as the light source may not necessarily offer sufficient performance.

This embodiment considers the point described above.

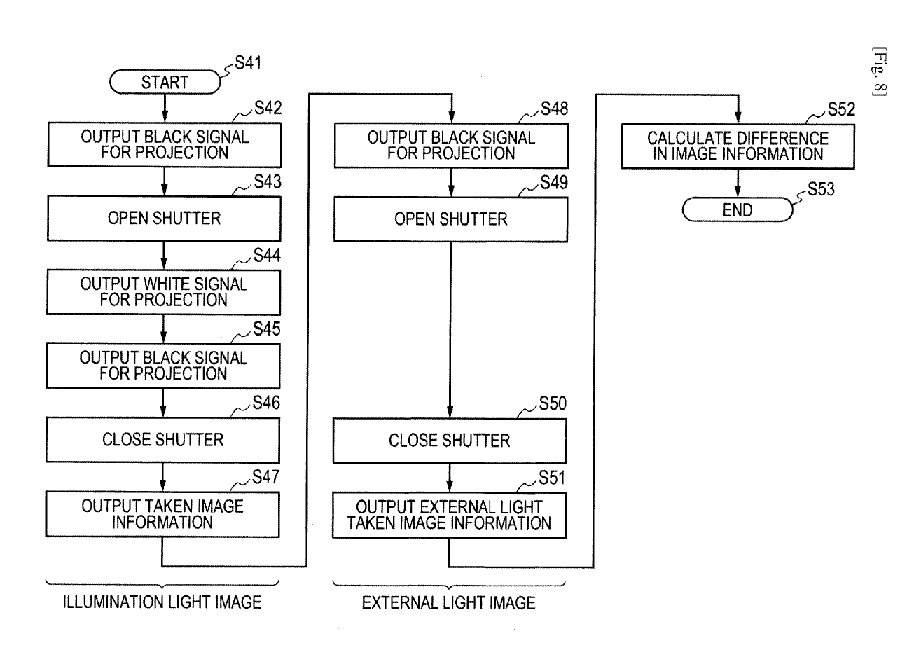

FIG. 8 is a flow chart of the image reading operation of the image reading apparatus according to the third embodiment.

When the image reading apparatus according to the third embodiment starts the image reading operation (S41), the control unit 106 outputs, to the projector 104, the black signal for projecting black in the imaging range 103e (S42). With this, the imaging range 103e in which the original is set is in a state of being illuminated only with external light.

Then, the shutter 103c of the camera 103 is opened (S43). With this, exposure of the camera 103 is made only with external light.

After that, the control unit 106 outputs, to the projector 104, a white signal for projecting white in the imaging range 103e (S44). With this, the imaging range 103e in which the original is set is in a state of being illuminated with external light and white projected from the projector. Under this state, exposure of the camera 103 is made.

Then, the control unit 106 outputs, to the projector 104, the black signal for projecting black in the imaging range 103e (S45). With this, the imaging range 103e in which the original is set is again in the state of being illuminated only with external light.

Next, the shutter 103c of the camera 103 is closed (S46). Taken image information that is obtained is output from the camera 103 to the control unit 106 (S47).

Then, the control unit 106 outputs, to the projector 104, the black signal for projecting black in the imaging range 103e (S48). With this, the imaging range 103e in which the original is set is in the state of being illuminated only with external light.

Next, the shutter 103c of the camera 103 is opened (S49). With this, exposure of the camera 103 is made only with external light.

Next, the shutter 103c of the camera 103 is closed (S50). External light taken image information that is obtained is output from the camera 103 to the control unit 106 (S51).

Finally, the control unit 106 calculates difference between the taken image information and the external light taken image information that are input and obtains a differential image without the influence of external light (S52), and the image reading apparatus according to the third embodiment ends the image reading operation (S53).

In the image reading apparatus according to this embodiment, the projector 104 projects a first black image, a white image, and a second black image in this order. At a first timing while the first black image is projected, the camera 103 opens the shutter 103c and starts imaging. At a second timing while the second black image is projected, the camera 103 closes the shutter 103c, ends the imaging, and obtains a first taken image of the original. After that, at a third timing while the second black image is projected, the camera 103 opens the shutter 103c and starts imaging. At a fourth timing while the second black image is projected, the camera 103 closes the shutter 103c, ends the imaging, and obtains a second taken image of the original. Finally, the control unit 106 calculates difference between the first taken image and the second taken image and obtains a differential image.

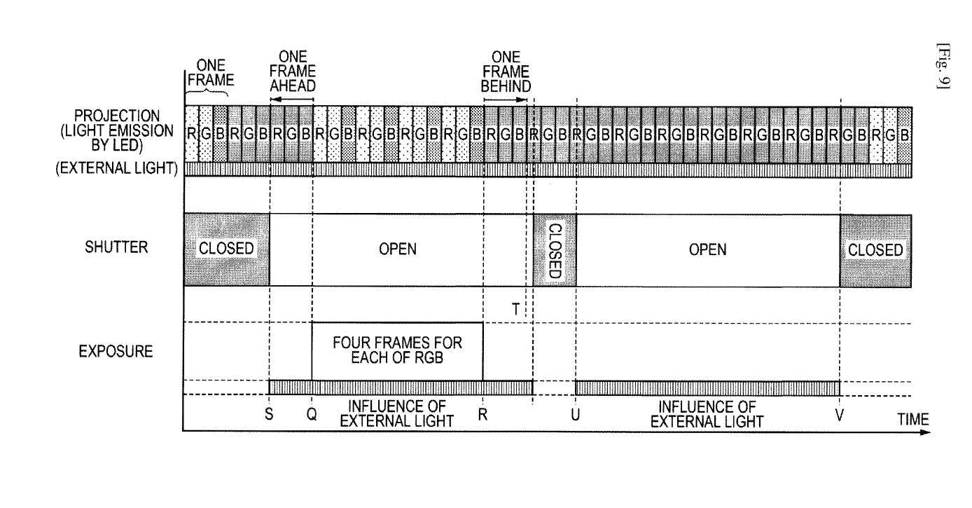

FIG. 9 is an imaging timing chart of the image reading apparatus according to the third embodiment.

The projector 104 performs the projection through light emission by the LEDs 104c in the order of RGB, and a cycle of RGB light emission is defined as one frame as a reference. Note that, one frame is set to be 1/60 seconds.

In this embodiment, the control unit 106 outputs to the projector 104 the color signals for projecting respective colors in the imaging range 103e for 1/15 seconds, i.e., four frames so that the projector 104 illuminates the imaging range 103e in which the original is set. Specifically, a time period from a timing Q at which the white signal starts being output to the projector 104 to a timing R at which the next black signal starts being output to the projector 104 is four frames.

Taking into consideration error in the opening/closing of the shutter 103c, the control unit 106 sends, to the camera 103, a signal to instruct opening/closing of the shutter 103c so that the shutter 103c is open from a timing S that is one frame ahead of the timing Q to a timing T that is one frame behind the timing R. In this way, taken image information in the state of being illuminated with external light and white projected from the projector is obtained.

As illustrated in FIG. 9, the opening/closing timings of the shutter 103c deviate from the set values. However, the imaging range 103e in which the original is set is in the state of being illuminated only with external light around the opening/closing timings S and T. Therefore, the exposure of the camera 103 to the illumination by the projector 104 is not affected.

Then, the control unit 106 outputs the black signal to the projector 104, and sends, to the camera 103, the signal to instruct opening/closing of the shutter 103c so that the shutter 103c is open from a timing U to a timing V. In this way, external light taken image information in a state of being illuminated only with external light is obtained.

Difference between the taken image information and the external light taken image information that are obtained is calculated, thereby being capable of obtaining the differential image without the influence of external light.

The camera 103 has a substantial exposure amount of four frames for each of RGB, and the influence of external light is removed. Thus, colors of the taken image that is obtained are reproduction of original colors of the original image. Further, the exposure frame numbers are an integer, and thus, nonuniformity in density and color does not develop on the light receiving surface.

Note that, shutter open time for obtaining the taken image information and shutter open time for obtaining the external light taken image information are substantially the same.

Therefore, the image reading apparatus according to the third embodiment can read an image with highly accurate and stable density and color while illuminating the image with the color sequential projector even in a case in which a difference in intensity between external light and illumination light is small.

Next, an image reading apparatus according to a fourth embodiment of the present invention is described. In the image reading apparatus according to the fourth embodiment, the image pickup element 103b is a color sensor as illustrated in FIG. 13B.

In the first embodiment to the third embodiment, the camera is configured to take a still image by a mechanical shutter system. As the number of times of operation of the camera becomes larger, mechanical parts of the camera becomes liable to cause a failure, which is not preferred. Thus, in applications with a large number of times of imaging, it is preferred to employ a system not using a mechanical shutter. In this embodiment, continuous imaging is performed in an electronic manner without using a mechanical shutter.

All components in the image reading apparatus according to the fourth embodiment are the same as those in the image reading apparatus 100 according to the first embodiment, and thus, like reference symbols are used to designate like members and description of the components is omitted.

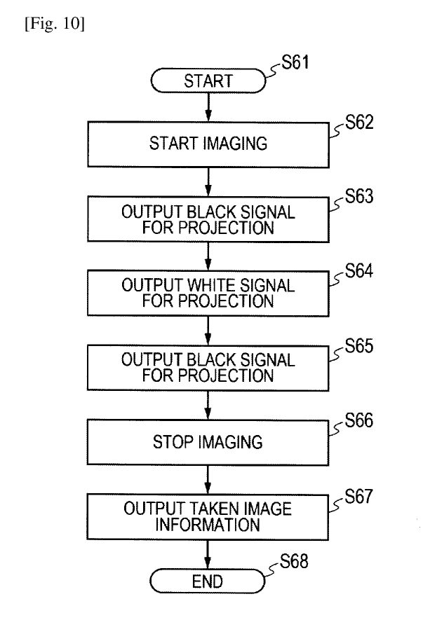

FIG. 10 is a flow chart of image reading operation of the image reading apparatus according to the fourth embodiment.

First, when the image reading apparatus starts the image reading operation (S61), the control unit 106 controls the camera 103 to start continuous imaging (S62). In continuous imaging, an image is transferred at every predetermined accumulation period, and a new image is taken.

Then, the control unit 106 outputs, to the projector 104, a black signal for projecting black in the imaging range 103e (S63). With this, the imaging range 103e in which the original is set is in a non-illuminated state.

Then, the control unit 106 outputs, to the projector 104, a white signal for projecting white in the imaging range 103e (S64). With this, the imaging range 103e in which the original is set is now in an illuminated state. At this time of outputting the white signal, exposure of the camera 103 substantially starts.

Then, the control unit 106 outputs, to the projector 104, the black signal for projecting black in the imaging range 103e (S65). With this, the imaging range 103e in which the original is set is again in the non-illuminated state.

Next, the imaging by the camera 103 is stopped (S66). Continuous taken image information that is obtained is output from the camera 103 to the control unit 106 (S67), and the image reading apparatus ends the image reading operation (S68).

An image that is taken before Step S63 including the moment of Step S63 and an image that is taken after Step S65 not including the moment of Step S65 are not used because nonuniformity in density and color, which is the problem to be solved by the present invention, develops in the images.

An exposure time for a taken image to be used is determined by a time period during which the white signal is output. Specifically, the exposure time corresponds to a time period from the time at which the white signal is output in Step S64 to the time at which the black signal is output in Step S65.

In the image reading apparatus according to this embodiment, the projector 104 projects a first black image, a white (first color) image, and a second black image in this order. The camera 103 performs continuous imaging to obtain images taken during the time period from the projection of the first black image to the projection of the second black image.

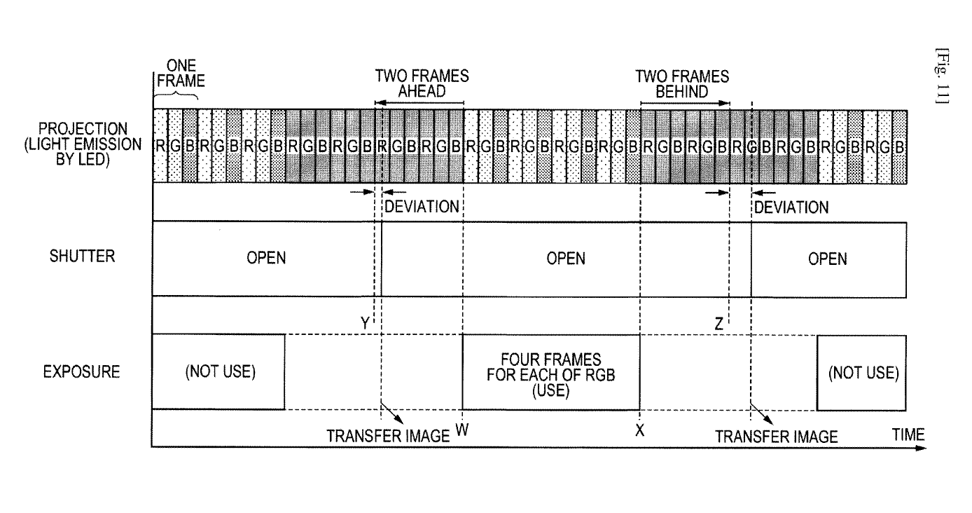

FIG. 11 is an imaging timing chart of the image reading apparatus according to the fourth embodiment.

Projecting operation of the projector 104 is the same as that in the first embodiment.

Taking into consideration synchronization error with the camera 103 performing continuous imaging, the control unit 106 sends an instruction signal regarding continuous imaging by the camera 103 so that imaging is switched at a timing Y that is two frames ahead of a timing W and at a timing Z that is two frames behind a timing X to transfer images.

As illustrated in FIG. 11, the timings of continuous imaging deviate from the set values. However, the imaging range 103e in which the original is set is in the non-illuminated state around the timings Y and Z at which imaging is switched, and thus, the exposure between the timings Y and Z is not affected.

The camera 103 has a substantial exposure amount of four frames for each of RGB, and colors of the taken image that is obtained are reproduction of original colors of the original image. Further, the exposure frame numbers are an integer, and thus, nonuniformity in density and color does not develop on the light receiving surface.

In the image reading apparatus according to the present invention, the control unit processes an image that is taken, and transfers the processed image to a memory unit (not shown) such as an SD card. When the control unit transfers the taken image to a printer, a personal computer, or the like, the image reading apparatus according to the present invention can also be used as a copying machine or an image scanner. Further, through projection and display of the taken image by the projector, the projector can also be used for a preview function.

The exemplary embodiments of the present invention are described above, but the present invention is not limited to these embodiments and can be modified and changed variously within the scope of the gist thereof.

For example, the projection image element may also be liquid crystal. As the light source, a structure including a white light source and color filters may also be adopted in which a plurality of colors of light are sequentially emitted by switching the color filters. Further, the lens may also be a reflection optical system. Further, a higher or lower frame rate can obtain a similar effect.

The camera may be a still camera or a video camera.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-242900, filed Dec. 1, 2014, and Japanese Patent Application No. 2015-211970, filed Oct. 28, 2015, which are hereby incorporated by reference herein in their entirety.

### REFERENCE SIGNS LIST

100 image reading apparatus
101a mounting surface
103 camera (image pickup unit)
104 projector (projecting unit)
106 control unit

1-19. (canceled)

20. An image reading apparatus, comprising:
an image pickup unit configured to image an original that is mounted on a mounting surface;
a projecting unit configured to project an image on the mounting surface by sequentially switching and emitting light of a plurality of colors; and
a control unit configured to control the projecting unit so as to project a first black image, a first color image, and a second black image in this order during the imaging by the image pickup unit.

21. The image reading apparatus according to claim 20, wherein the control unit is configured to control the image pickup unit so as to start the imaging while the first black image is projected and to end the imaging while the second black image is projected.

22. The image reading apparatus according to claim 20, wherein the plurality of colors comprise red, green, and blue.

23. The image reading apparatus according to claim 22, wherein the control unit is configured to control the projecting unit so as to project the first black image, a red image, the second black image, a green image, a third black image, a blue image, and a fourth black image in this order during the imaging by the image pickup unit.

24. The image reading apparatus according to claim 23, wherein the control unit is configured to obtain an image of the original by combining taken images obtained by the image pickup unit while the red image, the green image, and the blue image are projected.

25. The image reading apparatus according to claim 23, wherein the control unit is configured to:
control the image pickup unit so as to obtain a first taken image by starting the imaging while the first black image is projected and by ending the imaging while the second black image is projected, to obtain a second taken image by starting the imaging while the second black image is projected and by ending the imaging while the third black image is projected, and to obtain a third taken image by starting the imaging while the third black image is projected and by ending the imaging while the fourth black image is projected; and
obtain an image of the original by combining the first, second, and third taken images.

26. The image reading apparatus according to claim 20, wherein the first color image comprises a white image obtained through sequential emission of light in red, green, and blue.

27. The image reading apparatus according to claim 26, wherein the control unit is configured to control the projecting unit so as to project the first black image, the white image, and the second black image in this order.

28. The image reading apparatus according to claim 27, wherein the control unit is configured to obtain an image of the original by combining a first taken image obtained by the image pickup unit while the white image is projected and a second taken image obtained by the image pickup unit while the second black image is projected.

29. The image reading apparatus according to claim 27, wherein the control unit is configured to:
control the image pickup unit so as to obtain a first taken image by starting the imaging at a first timing while the first black image is projected and by ending the imaging at a second timing while the second black image is projected, and to obtain a second taken image by starting the imaging at a third timing while the second black image is projected and by ending the imaging at a fourth timing while the second black image is projected; and
obtain an image of the original from difference between the first taken image and the second taken image.

30. The image reading apparatus according to claim 29, wherein a time period between the first timing and the second timing and a time period between the third timing and the fourth timing are the same.

31. The image reading apparatus according to claim 20, wherein the projecting unit comprises a red light source, a green light source, and a blue light source.

32. The image reading apparatus according to claim 20,
wherein the image pickup unit comprises:
an image pickup element configured to receive light from the original; and
a shutter configured to block light from reaching the image pickup element, and
wherein the control unit is configured to control the image pickup unit so as to open the shutter while the first black image is projected and to close the shutter while the second black image is projected.

33. The image reading apparatus according to claim 20, wherein an image pickup range on the mounting surface in which the image pickup unit performs the imaging is included in a projection range in which the projecting unit projects the image.

34. The image reading apparatus according to claim 33, wherein the projecting unit is configured to project the image in a region of the projection range other than the image pickup range.

35. The image reading apparatus according to claim 20, wherein the control unit is configured to control the image pickup unit and the projecting unit so that the imaging and the projection are repeated.

36. The image reading apparatus according to claim 20, wherein the projecting unit is configured to project the image via a projection image element for displaying the image.

37. The image reading apparatus according to claim 20, wherein the control unit is configured to control the image pickup unit so as to start the imaging at or ahead of a fifth timing that is one frame ahead of a sixth timing at which the first color image is projected by the projecting unit.

38. The image reading apparatus according to claim 20, wherein the control unit is configured to control the image pickup unit so as to end the imaging at or behind a seventh timing that is one frame behind a eighth timing at which the first color image is projected by the projecting unit.
